(19) United States
(12) Patent Application Publication
(10) Pub. No.: US 2012/0014128 A1
(43) Pub. Date: Jan. 19, 2012

(54) ILLUMINATION APPARATUS

(76) Inventor: Yu-Yuan Lin, Taipei City (TW)

(21) Appl. No.: 13/171,397

(22) Filed: Jun. 28, 2011

(30) Foreign Application Priority Data
Jul. 15, 2010 (TW) 099123280

(51) Int. Cl. F21V 29/00; G02B 6/00

(52) U.S. Cl. 362/580; 362/551

(57) ABSTRACT

An illumination apparatus is disclosed and includes a light-guiding module and a light source module. The light-guiding module has a light-in surface, which is annular surface inside the light-guiding module. The light source module includes a plurality of light-emitting devices. Each light-emitting device is disposed toward the light-in surface and can emit light through the light-in surface into the light-guiding module. The light-guiding module can be a light-guiding plate with a through hole, a sidewall of which is treated as the light-in surface. The light source module can use an annular circuit board disposed in the through hole. The light-emitting devices are disposed on an outer annular surface of the annular circuit board toward the sidewall. Thereby, the invention can provide illumination of radially guiding light.

### BACKGROUND OF THE INVENTION

1. Field of the Invention

The invention relates to an illumination apparatus, and especially relates to an illumination apparatus capable of providing illumination of radially guiding light.

2. Description of the Prior Art

As various light sources develop, the light-emitting diodes (LED) are progressively applied in the field of illumination because of the improvement in its power. To an LED illumination apparatus with a single point source, its luminance and illumination area are too limited to be illumination for reading; the bright spot due to the point source makes eyes of a user uncomfortable. In order to increase the integral luminance of the illumination apparatus, it usually uses a plurality of high power LEDs arranged in plane and additionally uses a lamp cover for properly softening the light emitted by the high power LEDs to reduce the harsh feeling due to the point sources. This configuration is conducive to increasing the luminance and expanding the illumination area; however, the luminance uniformity is still insufficient.

There is a device providing a more uniform surface light by use of a light-guiding rod or plate as its light-mixing mechanism. The device has a plurality of point sources disposed on a side of the light-guiding plate. Light enters into the light-guiding plate through the side; then, the light passes through a surface of the light-guiding plate out of the light-guiding plate. The intensity of the light emitted from the light-guiding plate is substantially inversely proportional to the distance of the said light to the side, so there is a gradient change in the intensity of the surface light by the light-guiding plate.

There is another device using a light-guiding plate provided with a plurality of concaves thereon, each of which an LED is disposed. Light emitted by the LED enters into the light-guiding plate through the inner wall of the corresponding concave. A required illumination field shape can be obtained by designing the distribution of the concaves and the slant planes inside the concaves. However, in this case, its circuit structure is easily too large to maintain; besides, if the LED is high power, it is not conducive to the design for its heat-dissipating structure. Furthermore, for different-sized light-guiding plates, the structure details need to be designed respectively, which is quite unfavorable to production design and manufacturing.

### SUMMARY OF THE INVENTION

To the problem in the prior art, an objective of the invention is to provide an illumination apparatus capable of providing illumination of radially guiding light.

According to an embodiment, an illumination apparatus of the invention includes a light-guiding module and alight source module. The light-guiding module has a light-in surface, an annular surface disposed inside the light-guiding module. The light source module includes a plurality of light-emitting devices, each of which is disposed toward the light-in surface and is capable of emitting light into the light-guiding module through the light-in surface. Therefore, the light-emitting devices are disposed are disposed in annular arrangement. The light emitted from the light-emitting devices radially enters into the light-guiding module, so the profile of the light-guiding module can be no longer limited to rectangle, and the illumination field shape produced by the light-guiding module is various as well.

According to another embodiment, an illumination apparatus of the invention includes a light-guiding plate and an annular circuit board. The light-guiding plate has a through hole having a sidewall. The annular circuit board is disposed in the through hole and has an inner annular surface and an outer annular surface. There are light-emitting devices disposed on the outer annular surface and toward the sidewall. Similarly, the light emitted from the light-emitting devices radially enters into and travels inside the light-guiding module. Therefore, the illumination apparatus of the invention can produce various illumination field shapes.

Compared with the prior art, the illumination apparatus according to the invention uses the light-emitting devices disposed in annular arrangement to produce a radially light-guiding structure and further controls the disposition density of the light-emitting devices and the reflection light energy of the reflection structure produced by the light-guiding module so as easily to obtain uniform light out the light-guiding module. Even though the profile of the light-guiding module is irregular, the uniformity of the light out the light-guiding module is still improved effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an illumination apparatus of a preferred embodiment according to the present invention.

FIG. 2 is a sectional view of the illumination apparatus along the cutting line X-X in FIG. 1.

FIG. 3 is a sectional view of the illumination apparatus according to another embodiment.

FIG. 4 is a sectional view of the illumination apparatus according to another embodiment.

### DETAILED DESCRIPTION

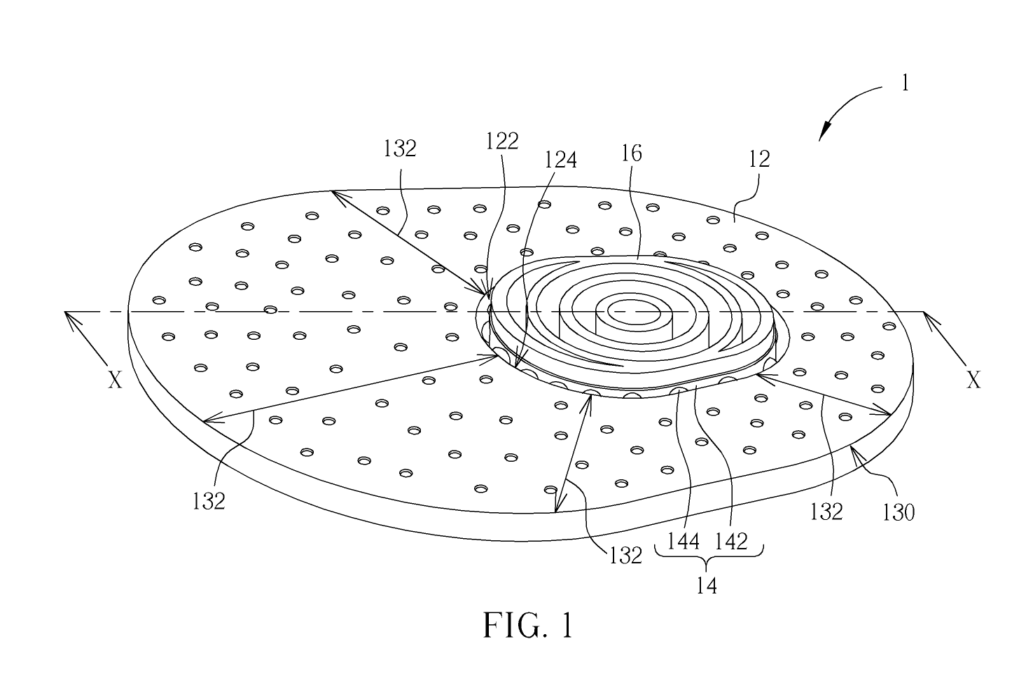

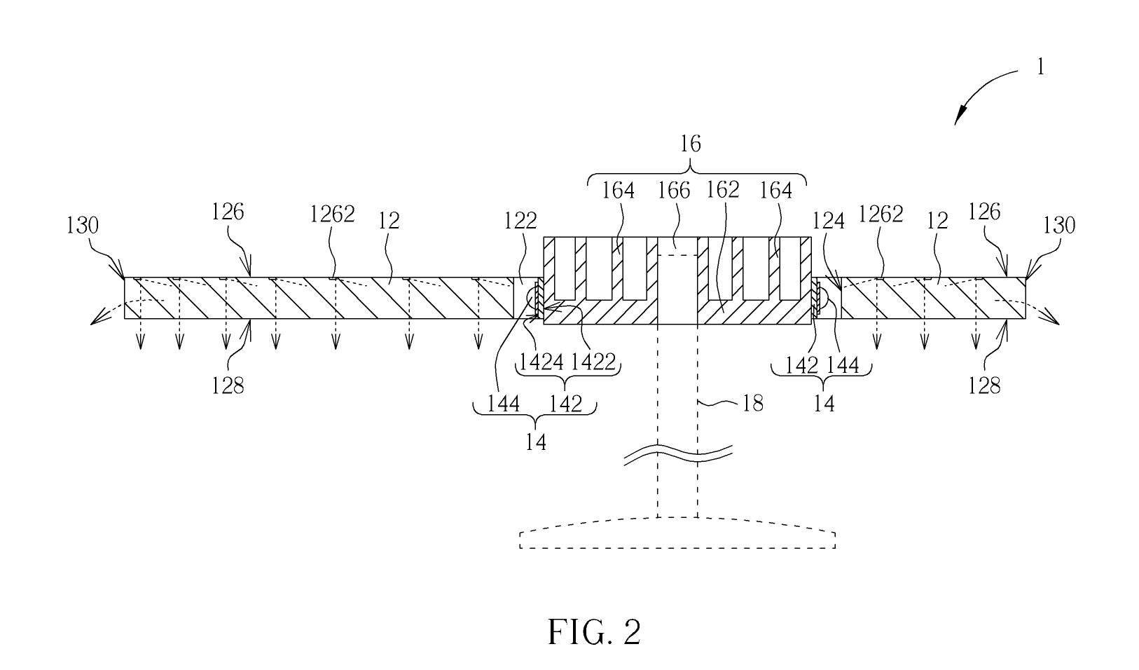

Please refer to FIG. 1 and FIG. 2. FIG. 1 is a schematic diagram of an illumination apparatus 1 of a preferred embodiment according to the present invention. FIG. 2 is a sectional view of the illumination apparatus 1 along the cutting line X-X in FIG. 1. The illumination apparatus 1 includes a light-guiding module 12, a light source module 14, and a heat-dissipating member 16. In the embodiment, the light-guiding module 12 is a light-guiding plate and has a through hole 122 having a sidewall as a light-in surface 124 of the light-guiding module 12; therefore, the light-in surface 124 is disposed inside the light-guiding module 12 and is an annular surface. The light source module 14 includes an annular circuit board 142 and a plurality of light-emitting devices 144. The annular circuit board 142 is disposed in the through hole 122 and has an inner annular surface 1422 and an outer annular surface 1424. The light-emitting devices 144 are disposed on the outer annular surface 1424 and toward the sidewall (i.e. the light-in surface 124). Thereby, light emitted from the light-emitting devices 144 can enter the light-guiding module 12 through the light-in surface 124 and then radially travel in the light-guiding module 12. The heat-dissipating member 16 is coupled to the inner annular surface 1422 so as to absorb heat produced in operation by the light-emitting device 144 by contact with the inner annular surface 1422.

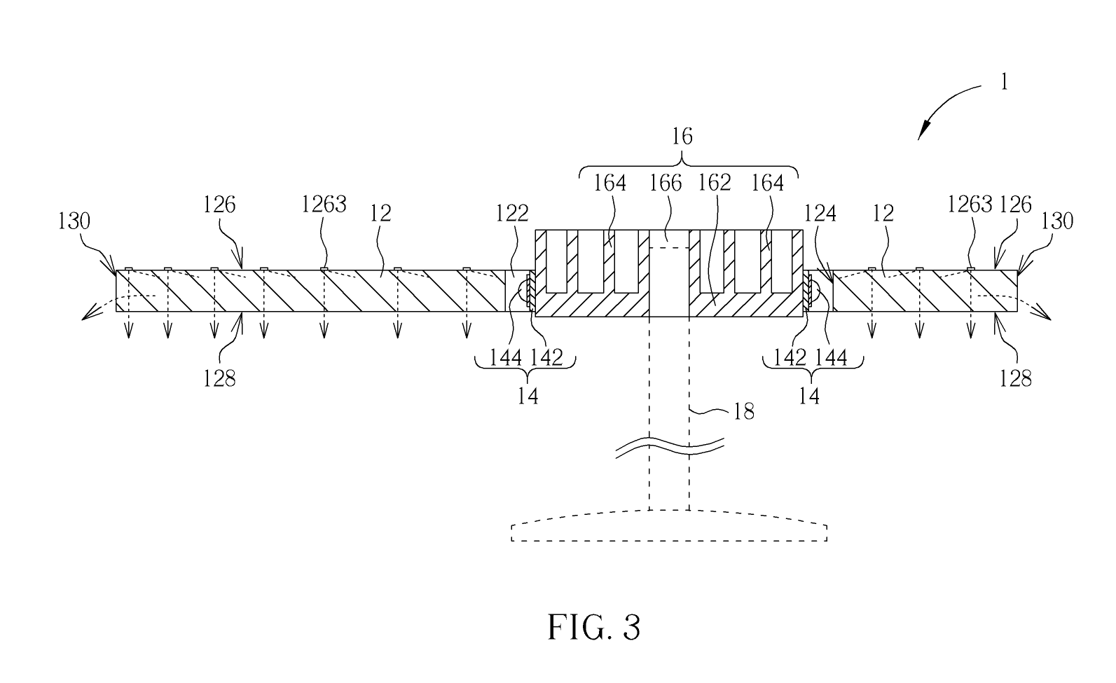

The light-guiding module 12 includes a first surface 126 and a second surface 128 opposite to the first surface 126. The first surface 126 thereon forms a plurality of indentations 1262 with slant plane. So when the light-emitting device 144 emits light, the light enters the light-guiding module 12 through the light-in surface 124 (which lies on the sidewall). The light entered the light-guiding module 12 then passes through the second surface 128 out of the light-guiding module 12 by use of reflection by the indentations 1262 or precisely the slant planes of the indentations 1262 on the first surface 126; therein, the reflection paths are shown in dashed lines. Most of the light entered the light-guiding module 12 passes through the second surface 128 by refraction or scattering; however, there is still a part of the light emitting out from an outer edge 130 of the light-guiding module 12. In the embodiment, the second surface 128 is taken as the primary light-out surface of the light-guiding module 12. The light-out surface is perpendicular to the light-in surface 124. Furthermore, the surface (i.e. the first surface 126) opposite to the second surface 128 (i.e. the light-out surface) thereon forms a reflection structure consisting mainly of the indentations 1262 to be capable of reflecting the light entered the light-guiding module 12; however, the invention is not limited to this. Please refer to FIG. 3, which is a sectional view of the illumination apparatus 1 according to another embodiment. The reflection structure in FIG. 3 consist mainly of a plurality of reflection spots 1263 coated (e.g. by printing) on the first surface 126. The reflection spots 1263 also can reflect the light entered the light-guiding module 12 to pass through the second surface 128.

Please refer to FIG. 1. In the embodiment, because the light travels radially in the light-guiding module 12, the farther the light reaches the place away from the light-emitting device 144 emitting the light, the lower the energy per unit area of the light is. Besides, the longer the distance the light travels in the light-guiding module 12 is, the more the probability that the light is reflected by the reflection structure is, so the farther the light reaches the place away from the light-emitting device 144 emitting the light, the lower the energy of the light is. Under the above double influence, the distribution density of the indentations 1262 or the reflection spots 1263 needs to be adjusted so that uniform light can be provided through the light-out surface (i.e. the second surface 128) of the light-guiding module 12. In principle, the distribution density of the indentations 1262 or the reflection spots 1263 close to the light source module 14 is lower than the distribution density of the indentations 1262 or the reflection spots 1263 far away from the light source module 14. The above explanation is based on the embodiment that the indentations 1262 or the reflection spots 1263 have the same size. In practice, the spot size for the indentations 1262 or the reflection spots 1263 in different area can be changed instead of the above adjustment for the distribution density, which can satisfy the above requirement of uniform light as well. In this case, in principle, the spot size for the indentations 1262 or the reflection spots 1263 close to the light source module 14 is smaller than the spot size for the indentations 1262 or the reflection spots 1263 far away from the light source module 14.

Furthermore, the light-guiding module 12 is made of plate material and is elliptic substantially. The light-emitting devices 144 are disposed in linear and annular arrangement corresponding to the light-in surface 124. Obviously, the distance for the light emitted by each of the light-emitting devices 144 travelling in the light-guiding module 12 is different. The problem mentioned above of the decrement of the light energy per unit area still exists herein. Therefore, in the embodiment, the distribution density of the light-emitting devices 144 can be proportional to the distance 132 from the light-in surface 124 corresponding to the light-emitting device 144 to the outer edge 130 of the light-guiding module 12, so as to reduce the decrement of the light energy per unit area mentioned above.

In addition, the annular circuit board 142 can be a flexible circuit board to be the medium for the electrical connection for the light-emitting devices 144. However, in practice, the light-emitting devices 144 can be attached one by one on the heat-dissipating member 16. The electrical connection thereof can be made by other ways such as additional wiring or respectively connecting by a flexible circuit board, which reduces the thermal resistance between the light-emitting device 144 and the heat-dissipating member 16. In a case that the power of the light-emitting device 144 increases, the benefit is more significant.

Please refer to FIG. 1 and FIG. 2. The heat-dissipating member 16 includes a body 162 and a plurality of annular fins 164 disposed on the body 162. The heat dissipation efficiency of the heat-dissipating member 16 can be improved by use of the annular fins 164. Furthermore, the body 162 thereon forms an opening 166, which a support 18 (shown in dashed lines in FIG. 2) can be engaged with to support the illumination apparatus 1.

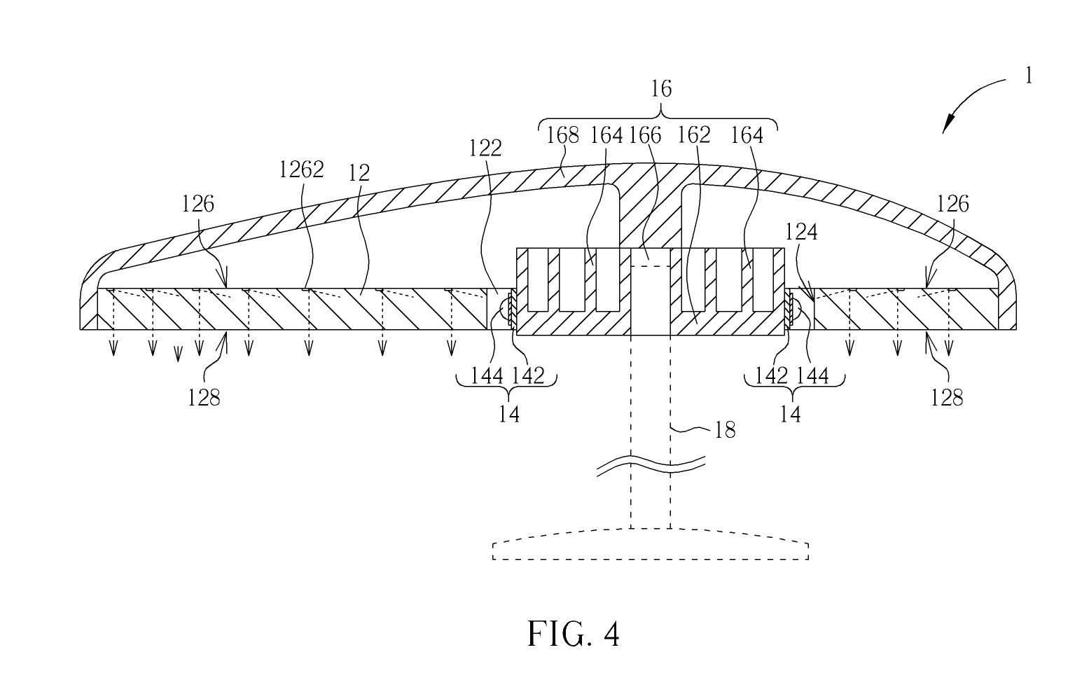

Please refer to FIG. 4, which is a sectional view of the illumination apparatus 1 according to another embodiment. For further improvement in the heat dissipation efficiency of the heat-dissipating member 16, the heat-dissipating member 16 can further include a heat-dissipating shell 168, connected to the body 162 and disposed above the light-guiding module 12, for upward dissipating heat in the heat-dissipating member 16. The heat-dissipating shell 168 can be designed to be integrated into a casing of the illumination apparatus 1.

Compared with the prior art, the illumination apparatus of the invention uses the light-emitting devices disposed in annular arrangement to produce a radially light-guiding structure and further controls the disposition density of the light-emitting devices and the reflection light energy of the reflection structure produced by the light-guiding module so as easily to obtain uniform light out the light-guiding module, which solves the problem that the uniformity of the illumination by a single point source in the prior art is insufficient. Moreover, even though the profile of the light-guiding module is irregular, the illumination apparatus of the invention can be easily modified on the basis of the above embodiments to be with a proper disposition density of the light-emitting devices and proper geometric features (for example, distribution density, spot size, and so on) of the reflection structure; hence, the illumination apparatus of the invention can improve the uniformity of the light out the light-guiding module effectively without changing too many design parameters, which solves the problem that change in the profile of the light-guiding module in the prior art leads to great modification of the distribution of the light-emitting devices and the size of the reflection structure. Furthermore, the heat-dissipating member of the illumination apparatus of the invention is disposed in the middle portion of the light-guiding module and also supports the light-guiding module for further reducing the whole volume of the illumination apparatus.

Those skilled in the art will readily observe that numerous modifications and alterations of the device and method may be made while retaining the teachings of the invention.

What is claimed is:

1. An illumination apparatus, comprising:
a light-guiding module, having a light-in surface, the light-in surface being an annular surface and being disposed inside the light-guiding module; and
a light source module, comprising a plurality of light-emitting devices, each light-emitting device being disposed toward the light-in surface and emitting light into the light-guiding module through the light-in surface.

2. The illumination apparatus of claim 1, wherein the light source module further comprises:
an annular circuit board, having an inner annular surface and an outer annular surface, the light-emitting devices being disposed on the outer annular surface; and
a heat-dissipating member, disposed near the inner annular surface.

3. The illumination apparatus of claim 2, wherein the heat-dissipating member further comprises:
a body;
a plurality of annular fins disposed on the body;
an opening formed in the body, for engaging with a support, the support being used for supporting the illumination apparatus; and
a heat-dissipating shell, disposed above the light-guiding module, for dissipating heat in the heat-dissipating member.

4. The illumination apparatus of claim 1, wherein the light-guiding module has a light-out surface for light having entered the light-guiding module to pass through, and the light-out surface is perpendicular to the light-in surface.

5. The illumination apparatus of claim 4, wherein the light-guiding module has a surface opposite to the light-out surface and comprises a reflection structure on the surface, and the reflection structure is capable of reflecting the light having entered the light-guiding module.

6. The illumination apparatus of claim 5, wherein the reflection structure comprises a plurality of indentations with slant plane formed on the surface or a plurality of reflection spots coated on the surface.

7. The illumination apparatus of claim 6, wherein a distribution density of the indentations or the reflection spots close to the light source module is smaller than a distribution density of the indentations or the reflection spots distant to the light source module.

8. The illumination apparatus of claim 6, wherein a spot size of the indentations or the reflection spots close to the light source module is smaller than a spot size of the indentations or the reflection spots distant to the light source module.

9. The illumination apparatus of claim 1, wherein the light-guiding module is a plate member and has an outer edge, the light-emitting devices are disposed in linear and annular arrangement corresponding to the light-in surface, and a distribution density of the light-emitting devices is proportional to a distance from the light-in surface corresponding to the light-emitting device to the outer edge.

10. An illumination apparatus, comprising:
a light-guiding plate, having a through hole, the through hole having a sidewall; and
an annular circuit board, disposed in the through hole, the annular circuit board having an inner annular surface and an outer annular surface, a plurality of light-emitting devices being disposed on the outer annular surface and toward the sidewall.

11. The illumination apparatus of claim 10, further comprising:
a heat-dissipating member, coupled to the inner annular surface.

12. The illumination apparatus of claim 10, wherein the light-guiding plate further comprises a first surface and a second surface opposite to the first surface, the first surface thereon forms a plurality of indentations with slant plane or is coated with a plurality of reflection spots, and when the light-emitting device emits light, the light enters into the light-guiding plate through the sidewall and is then reflected by the indentations or the reflection spots on the first surface to pass through the second surface out of the light-guiding plate.

13. An illumination apparatus, comprising:
a light-guiding plate, having a through hole;
a light source module disposed in the through hole and emitting light into a light-in surface of the through hole;
a heat-dissipating member disposed in the through hole and connecting the light source module, the heat-dissipating member comprising a heat-dissipating shell disposed above a first surface of the light-guiding plate; and
a support for engaging with a hole of the heat-dissipating member and for supporting the illumination apparatus.

14. The illumination apparatus of claim 13, wherein the light source module further comprises:
an annular circuit board, having an inner annular surface and an outer annular surface;
a plurality of light-emitting devices being disposed on the outer annular surface and toward the light-in surface of the through hole.

15. The illumination apparatus of claim 13, wherein the light-guiding plate has a second surface for emitting light which having entered the light-in surface of the through hole to pass through, and the second surface is perpendicular to the light-in surface of the through hole.

16. The illumination apparatus of claim 15, wherein the first surface comprises a reflection structure for reflecting the light having entered the light-guiding plate to the second surface.

17. The illumination apparatus of claim 16, wherein the reflection structure comprises a plurality of indentations with slant plane formed on the surface or a plurality of reflection spots coated on the surface.

18. The illumination apparatus of claim 17, wherein a distribution density of the indentations or the reflection spots close to the light source module is smaller than a distribution density of the indentations or the reflection spots distant from the light source module.
